(19) United States
(12) Patent Application Publication
(10) Pub. No.: US 2019/0064548 A1
(43) Pub. Date: Feb. 28, 2019

(54) PHOTOCHROMIC COMPOSITION, PHOTOCHROMIC OPHTHALMIC LENS, AND METHOD FOR MAKING PHOTOCHROMIC OPHTHALMIC LENS

(71) Applicant: HON HAI PRECISION INDUSTRY CO., LTD., New Taipei (TW)

(72) Inventor: HSIU-WEN CHIEN, New Taipei (TW)

(21) Appl. No.: 15/700,266

(22) Filed: Sep. 11, 2017

(30) Foreign Application Priority Data
Aug. 22, 2017 (TW) 106128478

(51) Int. Cl. G02C 7/10; C08B 37/16; C08F 251/00; C09K 9/02

(52) U.S. Cl. CPC G02C 7/102; C08B 37/0012; C08F 20/06; C09K 9/02; C08F 251/00

(57) ABSTRACT

A photochromic composition for opthalmic lens which colors or darkens in certain light includes a photochromic material and a binding polymer. The photochromic material includes cyclodextrins and photochromic molecules entrapped in cavities of the cyclodextrins. A single photochromic ophthalmic lens with, as a property, successively darker concentric rings under the certain light and a method for manufacturing the lens are also provided.

### FIELD

The subject matter herein generally relates to a photochromic material, and more particularly, to a photochromic composition, a photochromic ophthalmic lens having the photochromic composition, and a method for making the photochromic ophthalmic lens.

### BACKGROUND

Photochromic ophthalmic lenses have the ability to darken when exposed to light (such as sunlight).

### BRIEF DESCRIPTION OF THE DRAWINGS

Implementations of the present technology will now be described, by way of example only, with reference to the attached figures.

FIG. 1 is a cross-section view of an exemplary embodiment of a photochromic ophthalmic lens.

FIG. 2 is a top view of the photochromic ophthalmic lens in FIG. 1.

FIG. 3 is a top view of a photochromic ophthalmic lens according to another exemplary embodiment.

FIG. 4 is a top view of a photochromic ophthalmic lens according to a third exemplary embodiment.

FIG. 5 is a flowchart of an exemplary embodiment of a method for making a photochromic ophthalmic lens.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

The term “comprising,” when utilized, means “including, but not necessarily limited to”; it specifically indicates open-ended inclusion or membership in the so-described combination, group, series, and the like.

An exemplary embodiment of an opthalmic lens provides a photochromic composition. The photochromic composition includes a photochromic material and a binding polymer.

The photochromic material includes cyclodextrins and photochromic molecules entrapped in cavities of the cyclodextrins.

The photochromic material has a mass percentage of about 25% to about 67% of a total mass of the photochromic composition.

The photochromic molecules may darken or color under a light with certain wavelength and certain intensity (hereinafter “W & I light”), such as sunlight, and may recover to original state, when the light is removed. The above photochromic material maintains the properties of the photochromic molecules.

In at least one exemplary embodiment, the photochromic molecules can be selected from a group consisting of spiropyrans, spiroperimidines, diarylethenes, fulgides, hexaarylbiimidazole, azobenzenes, benzopyrylospiran, and any combination thereof.

The cyclodextrins can be α-cyclodextrin, β-cyclodextrin, γ-cyclodextrin, cyclodextrin derivatives, or any combination thereof.

In at least one exemplary embodiment, the cyclodextrins are cyclodextrin derivatives formed by modifying cyclodextrins by methacrylates. The cyclodextrin derivatives have methacrylate groups, and have a chemical diagram of

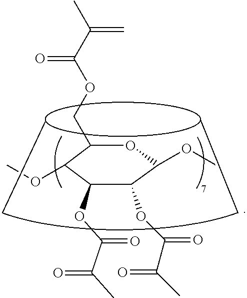

In at least one exemplary embodiment, the photochromic material can be obtained by mixing a photochromic solution and a cyclodextrin solution to obtain a mixed solution and then removing solvent from the mixed solution.

The photochromic solution is formed by adding the photochromic molecules to ethanol, tetrahydrofuran, or acetone. The cyclodextrin solution is formed by adding the cyclodextrins to water. The mixed solution is stirred to cause the photochromic molecules to be entrapped in the cavities of the cyclodextrins.

The photochromic solution may have a concentration of about 0.0001 mol/L to about 0.01 mol/L. The cyclodextrin solution may have a concentration of about 0.0001 mol/L to about 0.01 mol/L.

In at least one exemplary embodiment, the photochromic solution and the cyclodextrin solution are mixed with equal volumes.

The binding polymer includes at least one hydrophilic monomer, acrylic resin, at least one initiator, and at least one crosslinker.

The crosslinker can be ethylene glycol dimethacrylate (EGDMA), or compounds thereof.

The binding polymer may further include a solvent.

The hydrophilic monomer has a mass percentage of about 18% to about 35% of the total mass of the photochromic composition. The acrylic resin has a mass percentage of about 25% to about 42% of the total mass of the photochromic composition. The initiator has a mass percentage of about 0.5% to about 10% of the total mass of the photochromic composition. The crosslinker has a mass percentage of about 0.4% to about 16% of the total mass of the photochromic composition.

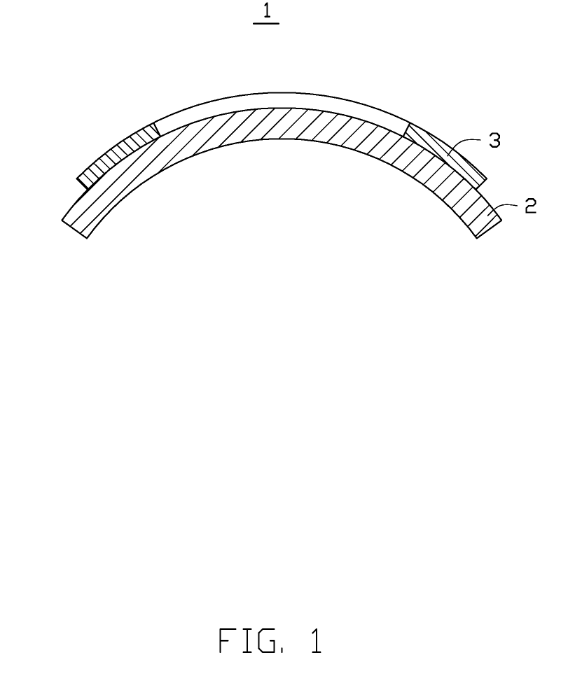

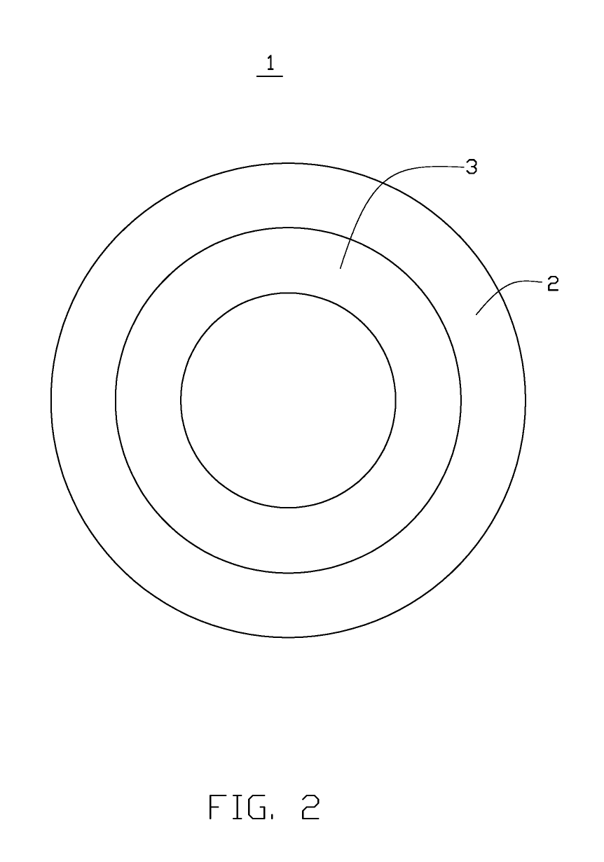

FIGS. 1 to 2 illustrate a photochromic ophthalmic lens 1 of another embodiment. The photochromic ophthalmic lens 1 includes a base 2 and a photochromic layer 3.

In at least one embodiment, when the photochromic ophthalmic lens 1 is a hydrogel lens, the base is hydrogel. When the photochromic ophthalmic lens 1 is a silicone hydrogel lens, the base is silicone hydrogel.

The photochromic layer 3 can be formed on inner side of the base 2, on outer side of the base 2, or on both.

The photochromic ophthalmic lens 1 will appear like a colored contact lens under W & I light, for the photochromic layer 3 may darken or color under the W & I light. The photochromic ophthalmic lens 1 may recover to original state without the W & I light.

In this exemplary embodiment, the photochromic layer 3 is polymerized by one photochromic composition. The photochromic layer 3 is in annular shape. The photochromic ophthalmic lens 1 has one color under W & I light.

In other exemplary embodiments, the photochromic layer 3 can be polymerized by two, three, or more than three photochromic compositions. The photochromic compositions can be arranged in concentric rings, or in arrangements other than concentric rings.

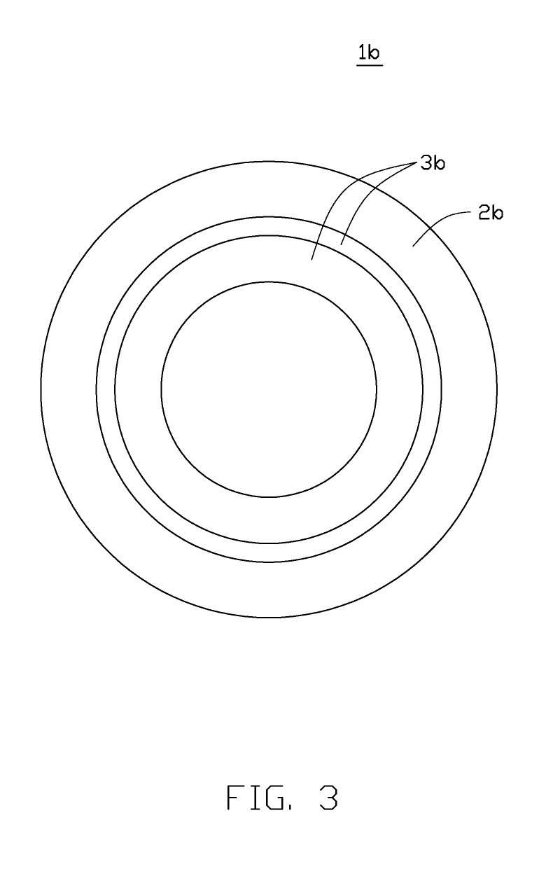

As shown in FIG. 3, the photochromic layer 3 is polymerized by two photochromic compositions. The two compositions have different colors under the W & I light. The two photochromic compositions are arranged in concentric rings. A color of an inner photochromic composition is lighter than a color of an outer photochromic composition. The photochromic ophthalmic lens 1 has two colors under W & I light.

The photochromic layer 3 may be polymerized by more than two photochromic compositions. The photochromic compositions may have different colors under W & I light. The photochromic compositions can be arranged in concentric rings. From an inner photochromic composition to an outer photochromic composition, colors of the three photochromic compositions are gradually darker. The photochromic ophthalmic lens 1 has gradations of color under W & I light.

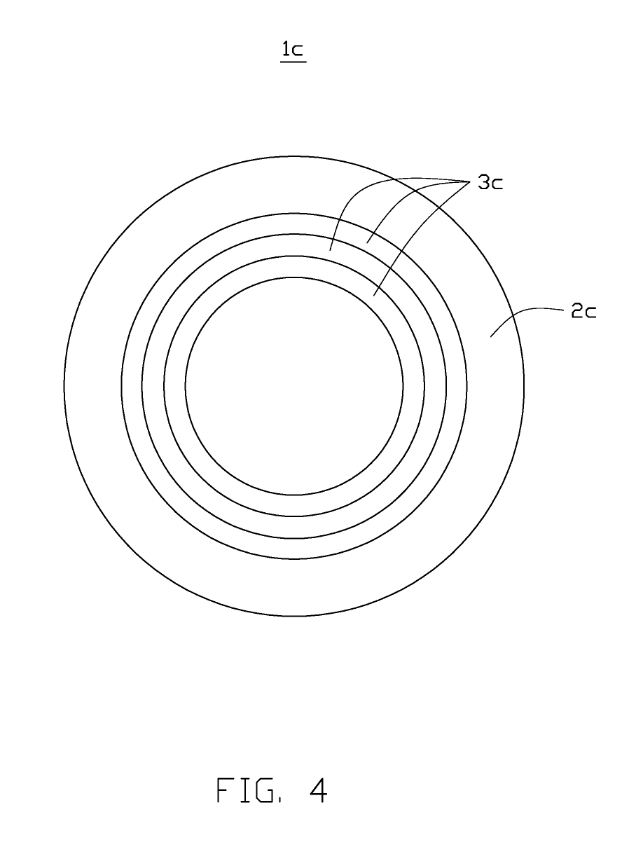

As shown in FIG. 4, the photochromic layer 3 is polymerized by three photochromic compositions. The three photochromic compositions have different colors under W & I light. The three photochromic compositions are arranged in concentric rings. From an inner photochromic composition to an outer photochromic composition, colors of the three photochromic compositions are gradually darker. The photochromic ophthalmic lens 1 has gradations of color under W & I light.

The photochromic composition includes a photochromic material and a binding polymer.

The photochromic material has a mass percentage of about 25% to about 67% of a total mass of the photochromic composition.

The photochromic material includes cyclodextrins and photochromic molecules entrapped in cavities of the cyclodextrins.

The photochromic molecules may assume color under a W & I light, and may recover to original state without the light. The above photochromic material maintains optical properties of the photochromic molecules.

In at least one exemplary embodiment, the photochromic molecules can be selected from a group consisting of spiropyrans, spiroperimidines, diarylethenes, fulgides, hexaarylbiimidazole, azobenzenes, benzopyrylospiran, and any combination thereof.

The cyclodextrins can be α-cyclodextrin, β-cyclodextrin, γ-cyclodextrin, cyclodextrin derivative, or any combination thereof.

In at least one exemplary embodiment, the cyclodextrins are cyclodextrin derivatives formed by modifying cyclodextrins by methacrylates. The cyclodextrin derivatives have methacrylate groups, and have a chemical diagram of

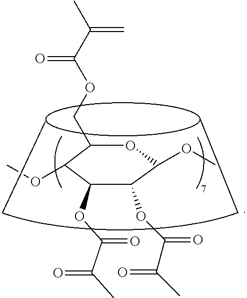

In at least one exemplary embodiment, the photochromic material can be formed by mixing a photochromic solution and a cyclodextrin solution to obtain a mixed solution and then removing solvent from the mixed solution.

The photochromic solution is formed by adding the photochromic molecules to ethanol, tetrahydrofuran, or acetone. The cyclodextrin solution is formed by adding the cyclodextrins to water. The mixed solution is stirred to cause the photochromic molecules to be entrapped in the cavities of the cyclodextrins.

The photochromic solution may have a concentration of about 0.0001 mol/L to about 0.01 mol/L. The cyclodextrin solution may have a concentration of about 0.0001 mol/L to about 0.01 mol/L.

In at least one exemplary embodiment, the photochromic solution and the cyclodextrin solution are mixed with equal volumes.

The binding polymer includes at least one hydrophilic monomer, acrylic resin, at least one initiator, and at least one crosslinker.

The crosslinker can be ethylene glycol dimethacrylate (EGDMA), or compounds thereof.

The binding polymer may further include a solvent.

The hydrophilic monomer has a mass percentage of about 18% to about 35% of the total mass of the photochromic composition. The acrylic resin has a mass percentage of about 25% to about 42% of the total mass of the photochromic composition. The initiator has a mass percentage of about 0.5% to about 10% of the total mass of the photochromic composition. The crosslinker has a mass percentage of about 0.4% to about 16% of the total mass of the photochromic composition.

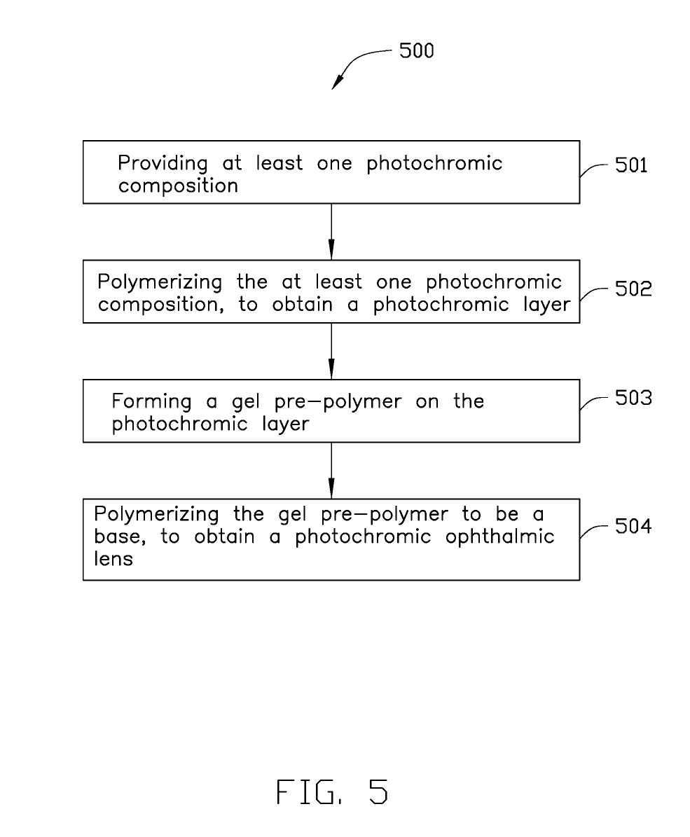

FIG. 5 illustrates a flowchart of an embodiment for a method for making a photochromic ophthalmic lens. The exemplary method is provided by way of example, as there are a variety of ways to carry out the method. Each block shown in the figure represents one or more processes, methods, or subroutines, carried out in the exemplary method. Furthermore, the illustrated order of blocks is by example only, and the order of the blocks can change. Additional blocks may be added or fewer blocks may be utilized, without departing from this disclosure. The exemplary method can begin at block 501.

At block 501, at least one photochromic composition is provided.

In this exemplary embodiment, the at least one photochromic composition can be formed in an upper half mold (not shown) of a mold and/or a lower half mold (not shown) of the mold.

The at least one photochromic composition is in annular shaped. when there is more than one photochromic compositions, the photochromic compositions can be arranged in concentric rings, or in arrangements other than concentric rings.

Each photochromic composition includes a photochromic material and a binding polymer.

The photochromic material has a mass percentage of about 25% to about 67% of a total mass of each photochromic composition.

The photochromic material includes cyclodextrins and photochromic molecules entrapped in cavities of the cyclodextrins.

The photochromic molecules may assume color under W & I light, such as sunlight, and may recover to original state, such as colorless, without the W & I light. The above photochromic material maintains optical properties of the photochromic molecules.

In at least one exemplary embodiment, the photochromic molecules can be selected from a group consisting of spiropyrans, spiroperimidines, diarylethenes, fulgides, hexaarylbiimidazole, azobenzenes, benzopyrylospiran, and any combination thereof.

The cyclodextrins can be α-cyclodextrin, β-cyclodextrin, γ-cyclodextrin, cyclodextrin derivative, or any combination thereof.

In at least one exemplary embodiment, the cyclodextrins are cyclodextrin derivatives formed by modifying cyclodextrins by methacrylates. The cyclodextrin derivatives have methacrylate groups, and have a chemical diagram of

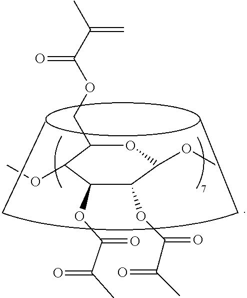

In at least one exemplary embodiment, the photochromic material can be formed by mixing a photochromic solution and a cyclodextrin solution to obtain a mixed solution and then removing solvent from the mixed solution.

The photochromic solution is formed by adding the photochromic molecules to ethanol, tetrahydrofuran, or acetone. The cyclodextrin solution is formed by adding the cyclodextrins to water. The mixed solution is stirred to cause the photochromic molecules to be entrapped in the cavities of the cyclodextrins.

The photochromic solution may have a concentration of about 0.0001 mol/L to about 0.01 mol/L. The cyclodextrin solution may have a concentration of about 0.0001 mol/L to about 0.01 mol/L.

In at least one exemplary embodiment, the photochromic solution and the cyclodextrin solution are mixed with equal volumes.

The binding polymer includes at least one hydrophilic monomer, acrylic resin, at least one initiator, and at least one crosslinker.

The crosslinker can be ethylene glycol dimethacrylate (EGDMA), or compounds thereof.

The binding polymer may further include a solvent.

The hydrophilic monomer has a mass percentage of about 18% to about 35% of the total mass of the photochromic composition. The acrylic resin has a mass percentage of about 25% to about 42% of the total mass of the photochromic composition. The initiator has a mass percentage of about 0.5% to about 10% of the total mass of the photochromic composition. The crosslinker has a mass percentage of about 0.4% to about 16% of the total mass of the photochromic composition.

At block 502, the photochromic composition is polymerized to form a photochromic layer.

The photochromic composition may be fully polymerized or semi-polymerized.

At block 503, a gel pre-polymer is provided and formed on the photochromic layer.

In this exemplary embodiment, the gel pre-polymer is filled into the mold.

The gel pre-polymer can be hydrogel pre-polymer or silicone hydrogel pre-polymer.

At block 504, the gel pre-polymer is polymerized to be a base, to obtain a photochromic ophthalmic lens.

If the photochromic composition is semi-polymerized at block 102, the photochromic composition can be polymerized at block 104 accompany by polymerizing the gel pre-polymer.

The photochromic composition and the gel pre-polymer can be polymerized under heating or ultraviolet radiation.

Depending on the embodiment, certain of the steps of methods hereinbefore described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A photochromic composition, comprising:
a photochromic material, the photochromic material comprising cyclodextrins and photochromic molecules entrapped in cavities of the cyclodextrins; and
a binding polymer.

2. The photochromic composition of claim 1, wherein the photochromic molecules is selected from a group consisting of spiropyrans, spiroperimidines, diarylethenes, fulgides, hexaarylbiimidazole, azobenzenes, benzopyrylospiran, and any combination thereof.

3. The photochromic composition of claim 1, wherein the cyclodextrins are cyclodextrin derivatives formed by modifying cyclodextrins by methacrylates, the cyclodextrin derivatives have methacrylate groups, and have a chemical diagram of

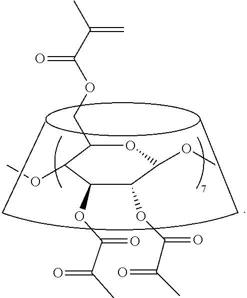

4. The photochromic composition of claim 1, wherein the photochromic material has a mass percentage of about 25% to about 67% of a total mass of the photochromic composition.

5. The photochromic composition of claim 1, wherein the binding polymer comprises at least one hydrophilic monomer, acrylic resin, at least one initiator, and at least one crosslinker; the hydrophilic monomer has a mass percentage of about 18% to about 35% of the total mass of the photochromic composition, the acrylic resin has a mass percentage of about 25% to about 42% of the total mass of the photochromic composition, the initiator has a mass percentage of about 0.5% to about 10% of the total mass of the photochromic composition, and the crosslinker has a mass percentage of about 0.4% to about 16% of the total mass of the photochromic composition.

6. A photochromic ophthalmic lens, comprising:
a base; and
a photochromic layer, the photochromic layer is polymerized by at least one photochromic composition;
wherein the photochromic composition comprises:
a photochromic material, the photochromic material comprising cyclodextrins and photochromic molecules entrapped in cavities of the cyclodextrins; and
a binding polymer.

7. The photochromic ophthalmic lens of claim 6, wherein the photochromic molecules is selected from a group consisting of spiropyrans, spiroperimidines, diarylethenes, fulgides, hexaarylbiimidazole, azobenzenes, benzopyrylospiran, and any combination thereof.

8. The photochromic ophthalmic lens of claim 6, wherein the cyclodextrins are cyclodextrin derivatives formed by modifying cyclodextrins by methacrylates, the cyclodextrin derivatives have methacrylate groups, and have a chemical diagram of

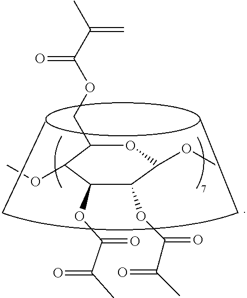

9. The photochromic ophthalmic lens of claim 6, wherein the photochromic material has a mass percentage of about 25% to about 67% of a total mass of the photochromic composition.

10. The photochromic ophthalmic lens of claim 6, wherein the binding polymer comprises at least one hydrophilic monomer, acrylic resin, at least one initiator, and at least one crosslinker; the hydrophilic monomer has a mass percentage of about 18% to about 35% of the total mass of the photochromic composition, the acrylic resin has a mass percentage of about 25% to about 42% of the total mass of the photochromic composition, the initiator has a mass percentage of about 0.5% to about 10% of the total mass of the photochromic composition, and the crosslinker has a mass percentage of about 0.4% to about 16% of the total mass of the photochromic composition.

11. The photochromic ophthalmic lens of claim 6, wherein the photochromic layer is polymerized by one photochromic composition, and the photochromic layer is in annular shaped, the photochromic ophthalmic lens has one color under a light with certain wavelength and certain intensity.

12. The photochromic ophthalmic lens of claim 6, wherein the photochromic layer is polymerized by two photochromic compositions, the two compositions have different colors under the light with certain wavelength and certain intensity, the two photochromic compositions are arranged in concentric rings, a color of an inner photochromic composition is lighter than a color of an outer photochromic composition, the photochromic ophthalmic lens has two colors under a light with certain wavelength and certain intensity.

13. The photochromic ophthalmic lens of claim 6, wherein the photochromic layer is polymerized by more than two photochromic compositions, the photochromic compositions have different colors under the light with certain wavelength and certain intensity, the photochromic compositions is arranged in concentric rings, from an inner photochromic composition to an outer photochromic composition, colors of the three photochromic compositions are gradually darker, the photochromic ophthalmic lens has gradient colors under a light with certain wavelength and certain intensity.

14. A method for manufacturing a photochromic ophthalmic lens, comprising:
providing at least one photochromic composition, each photochromic composition comprises a photochromic material and a binding polymer, the photochromic material comprising cyclodextrins and photochromic molecules entrapped in cavities of the cyclodextrins;
polymerizing the at least one photochromic composition, to obtain a photochromic layer;
forming a gel pre-polymer on the photochromic layer;
polymerizing the gel pre-polymer to be a base, to obtain a photochromic ophthalmic lens.

15. The method of claim 14, wherein the photochromic molecules is selected from a group consisting of spiropyrans, spiroperimidines, diarylethenes, fulgides, hexaarylbiimidazole, azobenzenes, benzopyrylospiran, and any combination thereof.

16. The method of claim 14, wherein the cyclodextrins are cyclodextrin derivatives formed by modifying cyclodextrins by methacrylates, the cyclodextrin derivatives have methacrylate groups, and have a chemical diagram of

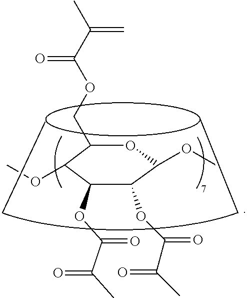

17. The method of claim 14, wherein the photochromic material is formed by mixing a photochromic solution and a cyclodextrin solution to obtain a mixed solution and then removing solvent from the mixed solution; the photochromic solution have a concentration of about 0.0001 mol/L to about 0.01 mol/L, the cyclodextrin solution have a concentration of about 0.0001 mol/L to about 0.01 mol/L.

18. The method of claim 14, wherein the photochromic material has a mass percentage of about 25% to about 67% of a total mass of each photochromic composition.

19. The method of claim 14, wherein the binding polymer comprises at least one hydrophilic monomer, acrylic resin, at least one initiator, and at least one crosslinker; the hydrophilic monomer has a mass percentage of about 18% to about 35% of the total mass of the photochromic composition, the acrylic resin has a mass percentage of about 25% to about 42% of the total mass of the photochromic composition, the initiator has a mass percentage of about 0.5% to about 10% of the total mass of the photochromic composition, and the crosslinker has a mass percentage of about 0.4% to about 16% of the total mass of the photochromic composition.

20. The method of claim 14, wherein the at least one photochromic composition is in annular shaped.
